(19) United States
(12) Patent Application Publication
(10) Pub. No.: US 2015/0006169 A1
(43) Pub. Date: Jan. 1, 2015

(54) FACTOR GRAPH FOR SEMANTIC PARSING

(71) Applicant: Google Inc., Mountain View, CA (US)

(72) Inventors: Fadi Biadsy, New York, NY (US); Pedro J. Moreno Mengibar, Jersey City, NJ (US)

(21) Appl. No.: 13/930,185

(22) Filed: Jun. 28, 2013

(51) Int. Cl. G10L 15/26

(52) U.S. Cl. CPC G10L 15/26
USPC 704/235

(57) ABSTRACT

Methods, systems, and apparatus, including computer programs encoded on a computer storage medium, for generating expressions associated with voice commands. The methods, systems, and apparatus include actions of obtaining segments of one or more expressions associated with a voice command. Further actions include combining the segments into a candidate expression and scoring the candidate expression using a text corpus. Additional actions include selecting the candidate expression as an expression associated with the voice command based on the scoring of the candidate expression.

### TECHNICAL FIELD

This disclosure generally relates to natural language processing.

### BACKGROUND

Expressions may be associated with voice commands. When an utterance is received and transcribed, a natural language processing system may attempt to match the transcription with an expression associated with a voice command. If the transcription matches an expression, the natural language processing system performs the voice command associated with the expression.

### SUMMARY

In general, an aspect of the subject matter described in this specification may involve a process for generating expressions associated with voice commands. The expressions may indicate words and arguments that match the expressions. For example, an expression associated with a voice command for setting an alarm may be “SET AN ALARM AT <TIME>,” where “<TIME>” may represent an argument representing a time in an utterance, e.g., “3 PM.” When a transcription of the utterance is matched to an expression, the voice command associated with the expression may be executed.

However, the utterances may slightly vary in form while still retaining the same underlying meaning. For example, the order of words or arguments in utterances may be different, or different words may be used in utterances. A transcription of an utterance “SET AT 3:00 PM AN ALARM,” for a voice command setting an alarm, may not match the expression “SET AN ALARM AT <TIME>,” because the words “AN ALARM” and “AT <TIME>” appear in a different order in the expression. Accordingly, multiple expressions representing different variations of utterances may be associated with the same voice command. For example, the expression “SET AT <TIME> AN ALARM” may also be associated with the voice command for setting an alarm.

Additional expressions may be generated based on existing expressions. Existing expressions may be segmented into one or more words and one or more arguments. For example, the expression “SET AN ALARM FOR <TIME>” may be segmented into the segments “SET AN ALARM” and “FOR <TIME>.” Rules for generating candidate expressions may be applied to the segments. For example, the rules may specify how to combine, omit, and add segments of expressions to generate candidate expressions. The candidate expressions may be scored, and the scores used to determine if the candidate expressions should be associated with voice commands and included in an expression database.

In some aspects, the subject matter described in this specification may be embodied in methods that may include the actions of obtaining segments of one or more expressions associated with a voice command. Further actions may include combining the segments into a candidate expression and scoring the candidate expression using a text corpus. Additional actions may include selecting the candidate expression as an expression associated with the voice command based on the scoring of the candidate expression.

Other versions include corresponding systems, apparatus, and computer programs, configured to perform the actions of the methods, encoded on computer storage devices.

These and other versions may each optionally include one or more of the following features. For instance, in some implementations a segment of the segments of text may include a word and an argument.

In additional aspects, obtaining segments may include obtaining the one or more expressions from an expression database, identifying syntactic constituents in the one or more expressions, and defining segments in the one more expressions based on the identification of the syntactic constituents.

In some implementations, the one or more expressions may include two or more expressions.

In certain aspects, combining the segments may include obtaining a rule for combining segments of expressions, and applying the rule to the obtained segments.

In additional aspects, scoring may include matching arguments in the candidate expression to text of the text corpus, and determining the accuracy of the matching. The selecting the candidate expression for inclusion in the expression database is based on determining the determined accuracy is greater than accuracy of matching of the expression database without the candidate expression.

In some implementations, the scoring may include determining the frequency that the candidate expression is matched to text in the text corpus, wherein selecting the candidate expression for inclusion in an expression database is based on determining the frequency is greater than a predetermined frequency threshold.

In certain aspects, the actions may further include, in response to selecting the candidate expression, adding the candidate expression to the expression database, receiving an utterance, matching a transcription of the utterance with the candidate expression, and, in response to matching the transcription of the utterance with the candidate expression, initiating an execution of the voice command associated with the candidate expression.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example system for generating expressions associated with voice commands.

FIG. 2 is a flowchart of an example process for generating expressions associated with voice commands.

FIG. 3 is a diagram of exemplary computing devices.

Like reference symbols in the various drawings indicate like elements.

### DETAILED DESCRIPTION

A system may initiate the execution of voice commands based on utterances from users. For example, when the user says “SET AN ALARM FOR 3:00 PM,” the system may execute a voice command to set an alarm for the user at 3:00 PM. To determine when a voice command should be executed, the system may match transcriptions of the utterances from users with expressions associated with voice commands.

An expression may be one or more words, one or more arguments, or a combination of words and arguments. For example, an expression may be “SET AN ALARM FOR <TIME>,” where the words “SET AN ALARM FOR” and the argument “<TIME>” may be associated with the voice command for setting an alarm. When matching utterances to expressions, the system may use automated speech recognition to transcribe the utterances and parse the transcriptions to determine an expression that matches the utterance.

When the system matches a transcription of an utterance to an expression, the system may execute a voice command associated with the expression. For example, the system may match the transcription of the utterance “SET AN ALARM FOR 3:00 PM” with the expression “SET AN ALARM FOR <TIME>,” and in doing so, the system may determine the argument “<TIME>” for the transcription of the utterance is “3:00 PM,” and based on the matching, execute a voice command for setting an alarm at 3:00 PM. To match transcriptions of utterances with expressions, the system may rely on pattern matching. Accordingly, the use of expressions to initiate the execution of voice commands in response to utterances may provide for high precision, maintainability, and clarity in the execution of voice commands.

However, users may use different words, ordering of words, and arguments in utterances for voice commands. Slight differences in structure or wording of utterances for a voice command may cause transcriptions of the utterances not to match to an expression associated with the voice command even if the underlying meaning of the utterance is the same. For example, the user may say “SET AT 3:00 PM AN ALARM” instead of “SET AN ALARM FOR 3:00 PM,” and the system may not match the transcription of the utterance “SET AT 3:00 PM AN ALARM” with the expression “SET AN ALARM AT <TIME>” as “AN ALARM” and “AT <TIME>” in the transcription of the utterance appear in a different order than in the expression.

To enable slight differences in structure or wording in utterances to be accurately matched to expressions associated with voice commands, multiple expressions may be associated with the same voice command. For example, the expression “SET AT <TIME> AN ALARM” may also be associated with the voice command for setting an alarm. The expressions associated with voice commands may be written by hand or generated from examples selected by people. However, generating expressions using these two approaches may be time consuming and tedious.

The system may generate additional expressions based on existing expressions associated with voice commands. To generate expressions for a particular voice command, the system may obtain segments of one or more expression associated with the particular voice command. A segment may include one or more words or one or more arguments, or a combination of one or more words and one or more arguments. For example, the expression “SET AN ALARM AT <TIME>” may be segmented into the segments “SET AN ALARM” and “AT <TIME>.”

The system may apply rules to the segments. The rules may specify ways to combine, omit, add, or replace segments of the expressions to generate candidate expressions. To ensure that the addition of a candidate expression improves performance of the system, the system may score the candidate expressions using a text corpus. The system may then use the scores to select a candidate expression as an expression associated with voice commands, and add the selected candidate expression to an expression database.

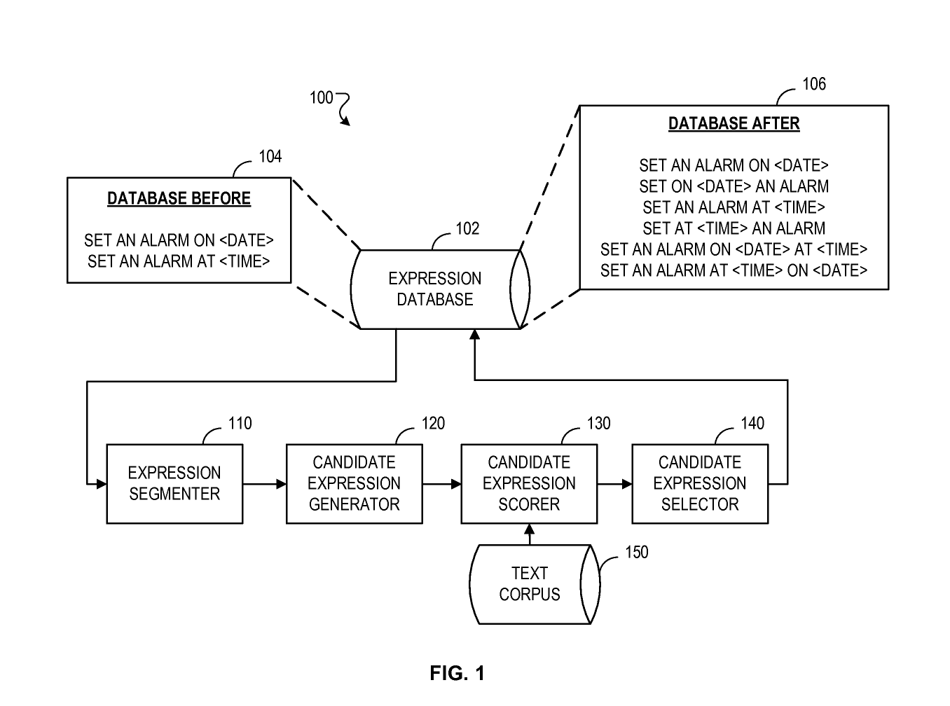

FIG. 1 is a block diagram of an example system 100 for generating expressions associated with voice commands. The system 100 may include an expression database 102. The database 102 may store one or more expressions that are associated with voice commands. For example, before table 104 shows the expression database initially storing two expressions. The first expression, “SET AN ALARM ON <DATE>,” is associated with a voice command for setting an alarm. The second expression, “SET AN ALARM AT <TIME>,” is also associated with the voice command for setting an alarm.

The system 100 further includes an expression segmenter 110. The segmenter 110 may segment one or more expressions in the expression database 102. For example, segmenter 110 may obtain the expression “SET AN ALARM ON <DATE>” from the database 102 and segment the expression into the segments “SET AN ALARM” and “ON <DATE>.” As another example, the segmenter 110 may segment the expression “SET AN ALARM FOR <TIME>” into the segments “SET,” “AN ALARM,” and “FOR <TIME>.” In segmenting expressions, the segmenter 110 may analyze the expression to identify the syntactic constituents of the expression, and segment the expression based on the identified syntactic constituents. For example, the segmenter 110 may identify verbs and nouns in an expression and segment the verbs and nouns into separate segments.

The system 100 may further include a candidate expression generator 120. The generator 120 may generate one or more candidate expressions based on the segments obtained by the segmenter 110. The generator 120 may re-order, omit, replace, or combine segments from different expressions. The generator 120 may also select segments to form a candidate expression.

For example, the generator 120 may re-order the segments in the expression “SET AN ALARM AT <TIME>” to generate the expression “SET AT <TIME> AN ALARM,” or the expression “AT <TIME> SET AN ALARM.” In another example, the generator 120 may omit segments in the expression “SET AN ALARM AT <TIME>” to generate the expression “ALARM AT <TIME>.” In yet another example, the generator 120 may replace the segment “AT <TIME>” with the segment “FOR <TIME>” to generate the expression “SET AN ALARM FOR <TIME>.”

The generator 120 may combine segments from two or more expression that are associated with the same voice command together. For example, the generator 120 may combine segments from the expression “SET AN ALARM AT <TIME>” with the expression “SET AN ALARM ON <DATE>” to generate an expression “SET AN ALARM AT <TIME> ON <DATE>” or generate the expression “SET AN ALARM ON <DATE> AT <TIME>.”

In generating the expressions, the generator 120 may rely on rules that may describe how particular segments may be re-ordered, omitted, replaced, or combined. For example, the generator 120 may obtain a rule that describes that particular words may be replaced with other words, e.g., the word “AT” may be replaced with “FOR,” or a rule that describes that particular words may be placed in different positions, e.g., a segment including an argument that appears at the end of an expression may be moved to directly after the verb in the expression. Other rules may define how segments from different expressions associated with the same voice command may be combined together.

The system 100 may further include a candidate expression scorer 130. The scorer 130 may score the candidate expressions generated by the generator 120. The scorer 130 may score the accuracy and the frequency of use for each candidate expression. The scorer 130 may score the candidate expressions against text in a text corpus 150.

The text corpus 150 may be a collection of text. The text may include text from news articles, transcriptions of voice commands, web pages, or other publications. Portions of the text may be known to correspond to particular voice commands, and the scorer 130 may score candidate expressions based on if the text is accurately matched to candidate expressions associated with the particular voice commands corresponding to the text portions. For example, the text corpus may include the text “SET AT 3:00 PM AN ALARM” that is known to correspond to the voice command for setting an alarm. The scorer 130 may score the accuracy of the candidate expression based on if adding the candidate expression to the existing expressions increases the accuracy of matching expressions to the text.

For example, if the text “SET AT 3:00 PM AN ALARM” did not match to any expression until the candidate expression “SET AT <TIME> AN ALARM” is added, the candidate expression may be considered to increase the accuracy of matching if the argument “<TIME>” is also matched to the text “3:00 PM.” If the arguments are inaccurately matched, e.g., “<TIME>” is matched to text that is not “3:00 PM,” or the candidate expression is inaccurately matched to text that does not correspond to the voice command for which the candidate expression is generated, e.g., the candidate expression for setting an alarm is matched to text for sending an e-mail, the candidate expression may be scored as reducing accuracy.

For each expression, the scorer 130 may also score frequency of use of the expression. For example, the scorer may track the number of times that the candidate expression is matched to text in the text corpus to determine a number representing the number of times the candidate expression is matched or a rate at which the expression is matched to text.

The system 100 may further include a candidate expression selector 140. The selector 140 may select candidate expressions as an expression associated with the voice command based on the scores from the scorer 130. Candidate expressions selected as associated with a voice command may be added to the expression database 102 so that transcriptions of utterances from users may be matched to the candidate expression, and voice commands executed in response to the matches.

As an example of the selection performed by selector 140, the selector 140 may determine if the scoring for a candidate expression indicates that the candidate expression increases the accuracy of matching candidate expressions with text corresponding to voice commands. If the scoring indicates that the candidate expression does not increase accuracy or reduces accuracy, inclusion of the candidate expression in the expression database may reduce the accuracy of matching so the selector 140 may not select the candidate expression to be associated with the voice command.

If the candidate expression increases accuracy, the selector 140 may further determine if the scoring for the candidate expression indicates that the candidate expression is matched to text at least at a particular frequency, which may be represented by a predetermined threshold. For example, the selector 140 may determine if the candidate expression is matched at least ten times in a portion of a text corpus or is matched an average of at least once every hundred sentences. If the scoring indicates that the candidate expression is not matched to text at least at a particular frequency, the processing and storage cost of including the candidate expression in the database 102 may outweigh the benefit from the increase in accuracy of including the candidate expression in the database 102, so the selector 140 may not select the candidate expression to be associated with the voice command.

If the candidate expression both increases accuracy and is matched at least at a particular frequency, the selector 140 may select the candidate expression as an expression associated with the voice command and include the candidate expression in the database 102. The selector 140 may also use a different process for selecting a candidate expression as an expression associated with the voice command. For example, the selector 140 may first determine the frequency at which the candidate expression is matched, and then determine if the candidate expression increases accuracy. In another example, the selector 140 may only consider if the candidate expression considers accuracy. In other examples, the selector 140 may consider other factors in determining if the candidate expression should be associated with the voice command.

Table 106 shows an example of the expressions stored in the database after the system 100 generates additional expressions using the initial expressions in table 104. The table 106 may include the initial expressions “SET AN ALARM ON <DATE>” and “SET AN ALARM AT <TIME>,” as well as the additional expressions, “SET ON <DATE> AN ALARM,” “SET AT <TIME> AN ALARM,” “SET AN ALARM ON <DATE> AT <TIME>,” and “SET AN ALARM AT <TIME> ON <DATE>.”

Different configurations of the system 100 may be used where functionality of the expression segmenter 110, candidate expression generator 120, candidate expression scorer 130, candidate expression selector 140, and the text corpus 150 may be combined, further distributed, or interchanged. The system 100 may be implemented in a single device or distributed across multiple devices.

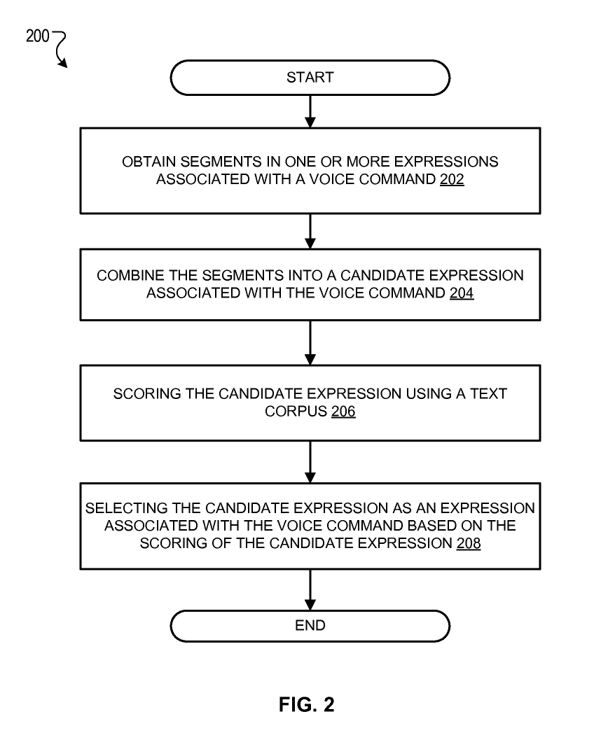

FIG. 2 is a flowchart of an example process 200 for generating expressions associated with voice commands. The following describes the process 200 as being performed by components of the system 100 that are described with reference to FIG. 1. However, the process 200 may be performed by other systems or system configurations.

The process 200 may include obtaining segments in one or more expressions associated with a voice command (202). For example, the expression segmenter 110 may obtain an expression from the expression database 102 and segment the expression into segments. In obtaining the segments, the segmenter 110 may identify all expressions in the expression database 102 that are associated with a particular voice command and segment the identified expressions. For example, the segmenter 110 may identify that the database 102 includes two expressions associated with a voice command for setting an alarm, “SET AN ALARM ON <DATE>” and “SET AN ALARM AT <TIME>,” and may segment the expressions into segments “SET,” “AN ALARM,” “ON <DATE>,” and “AT <TIME>.”

The process 200 may include combining the segments into a candidate expression associated with the voice command (204). The segments obtained by the segmenter 110 may be combined by the candidate expression generator 120 in a variety of ways to generate candidate expressions, as described above. For example, the segments “SET,” “AN ALARM,” “ON <DATE>,” “AT <TIME>” from the two expressions may be combined to form the candidate expression “SET AN ALARM AT <TIME> ON <DATE>.”

The process 200 may further include scoring the candidate expressions using a text corpus (206). The candidate expression generated by the generator 120 may be scored by the candidate expression scorer 130. As described above, the scorer 130 may use a text corpus to score the accuracy and frequency of use of candidate expressions. For example, the scorer 130 may associate a score with the candidate expression “SET AN ALARM AT <TIME> ON <DATE>” that indicates that the candidate expression increases the accuracy of matching by 5%, and indicates that the candidate expression is matched to text at the rate, e.g., frequency of use, of 1% of all sentences.

The process 200 may further include selecting the candidate expression as an expression associated with the voice command based on the scoring of the candidate expression (208). The candidate expression may be selected using the candidate expression selector 140 based on determining if a score of a candidate expression indicates that the accuracy of the candidate expression and frequency of use are above a predetermined threshold. For example, the candidate expression selector 140 may determine to select the candidate expression “SET AN ALARM AT <TIME> ON <DATE>” based on determining that the accuracy increase of 5% indicated by the score is greater than a predetermined threshold of 0% and the frequency of use of 1% indicated by the score is greater than a predetermined threshold of 0.2%.

As another example of a before and after candidate expression database, a before database may include the expressions shown in Table 1:

TABLE 1
BEFORE DATABASE
SET AN ALARM ON <DATE>
SET AN ALARM AT <TIME> TO REMIND ME TO <SUBJECT>

An after database may include the expressions shown in Table 2:

TABLE 2
AFTER DATABASE
SET AN ALARM ON <DATE>
SET AN ALARM AT <TIME> TO REMIND ME TO <SUBJECT>
SET AN ALARM AT <TIME> ON <DATE> TO REMIND ME TO
<SUBJECT>
ON <DATE> SET AN ALARM
ON <DATE> SET AN ALARM TO REMIND ME TO <SUBJECT>
ON <DATE> REMIND ME TO <SUBJECT>
SET AN ALARM ON <DATE> TO REMIND ME TO <SUBJECT>
SET AN ALARM ON <DATE> TO <SUBJECT>
SET AN ALARM AT <TIME>
SET AN ALARM AT <TIME> TO <SUBJECT>
AT <TIME> SET AN ALARM
AT <TIME> SET AN ALARM TO REMIND ME TO <SUBJECT>
AT <TIME> REMIND ME TO <SUBJECT>

As can be seen in Table 2 above, the segment “ON <DATE>” from the first expression may be replaced with the segment “AT <TIME>” to generate a new candidate expression. The various segments can also be re-ordered, for example, “SET AN ALARM ON <DATE>” can be re-ordered to “ON <DATE> SET AN ALARM.” Segments may be omitted, for example, segments from “SET AN ALARM AT <TIME> TO REMIND ME TO <SUBJECT>” may be omitted to generate the candidate expression “SET AN ALARM AT <TIME> TO <SUBJECT>.” Various segments from different expressions may be combined to form the candidate expression “SET AN ALARM AT <TIME> ON <DATE> TO REMIND ME TO <SUBJECT>.”

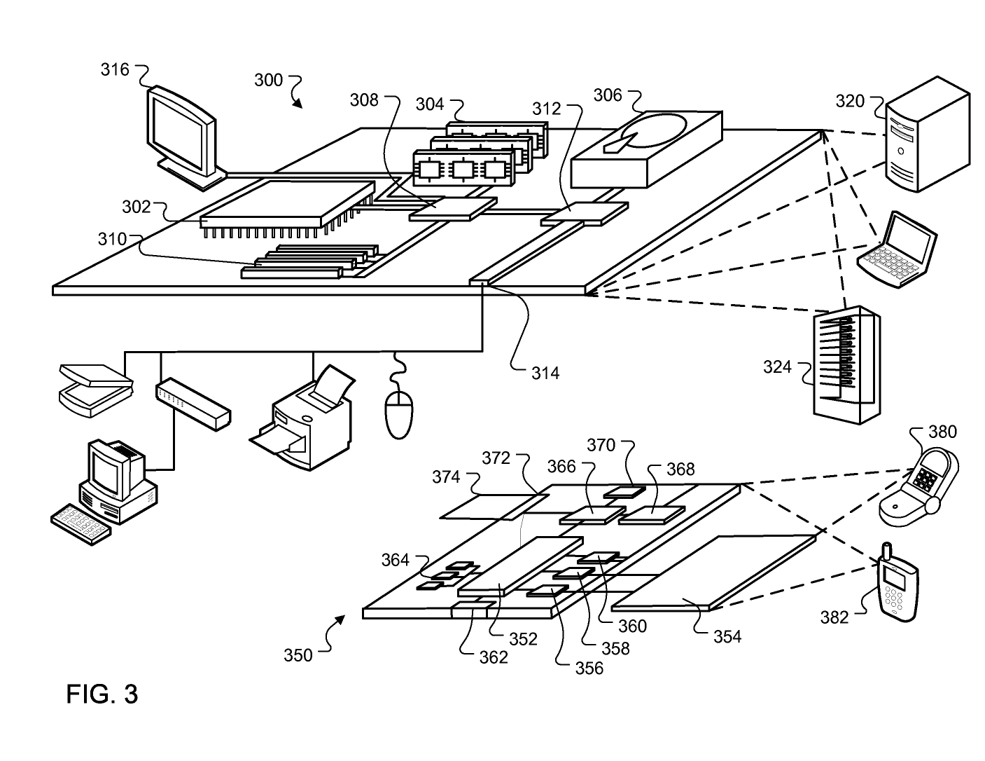

FIG. 3 shows an example of a computing device 300 and a mobile computing device 350 that can be used to implement the techniques described here. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine-readable mediums (for example, the memory 304, the storage device 306, or memory on the processor 302).

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 368 using a radio-frequency. In addition, short-range communication may occur, such as using a Bluetooth, WiFi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1. A computer-implemented method for generating expressions comprising:
obtaining segments of one or more expressions associated with a voice command;
combining the segments into a candidate expression;
scoring, by a processor, the candidate expression using a text corpus;
selecting the candidate expression as an expression associated with the voice command based on the scoring of the candidate expression.

2. The method of claim 1, wherein a segment of the segments of text comprises a word and an argument.

3. The method of claim 1, wherein obtaining segments comprises:
obtaining the one or more expressions from an expression database;
identifying syntactic constituents in the one or more expressions; and
defining segments in the one more expressions based on the identification of the syntactic constituents.

4. The method of claim 1, wherein the one or more expressions comprise two or more expressions.

5. The method of claim 1, wherein combining the segments comprises:
obtaining a rule for combining segments of expressions; and
applying the rule to the obtained segments.

6. The method of claim 1, wherein scoring comprises:
matching arguments in the candidate expression to text of the text corpus; and
determining the accuracy of the matching,
wherein selecting the candidate expression for inclusion in the expression database is based on determining the determined accuracy is greater than accuracy of matching of the expression database without the candidate expression.

7. The method of claim 1, wherein scoring comprises:
determining the frequency that the candidate expression is matched to text in the text corpus,
wherein selecting the candidate expression for inclusion in an expression database is based on determining the frequency is greater than a predetermined frequency threshold.

8. The method of claim 1, further comprising:
in response to selecting the candidate expression, adding the candidate expression to the expression database;
receiving an utterance;
matching a transcription of the utterance with the candidate expression; and
in response to matching the transcription of the utterance with the candidate expression, initiating an execution of the voice command associated with the candidate expression.

9. A computer-readable medium storing software comprising instructions executable by one or more computers which, upon such execution, cause the one or more computers to perform operations comprising:
obtaining segments of one or more expressions associated with a voice command;
combining the segments into a candidate expression;
scoring the candidate expression using a text corpus;
selecting the candidate expression as an expression associated with the voice command based on the scoring of the candidate expression.

10. The medium of claim 9, wherein a segment of the segments of text comprises a word and an argument.

11. The medium of claim 9, wherein obtaining segments comprises:
obtaining the one or more expressions from an expression database;
identifying syntactic constituents in the one or more expressions; and
defining segments in the one more expressions based on the identification of the syntactic constituents.

12. The medium of claim 9, wherein combining the segments comprises:
obtaining a rule for combining segments of expressions; and
applying the rule to the obtained segments.

13. The medium of claim 9, wherein scoring comprises:
matching arguments in the candidate expression to text of the text corpus; and
determining the accuracy of the matching,
wherein selecting the candidate expression for inclusion in the expression database is based on determining the determined accuracy is greater than accuracy of matching of the expression database without the candidate expression.

14. The medium of claim 9, wherein scoring comprises:
determining the frequency that the candidate expression is matched to text in the text corpus,
wherein selecting the candidate expression for inclusion in an expression database is based on determining the frequency is greater than a predetermined frequency threshold.

15. A system comprising:
one or more computers and one or more storage devices storing instructions that are operable, when executed by the one or more computers, to cause the one or more computers to perform operations comprising:
obtaining segments of one or more expressions associated with a voice command;
combining the segments into a candidate expression;
scoring the candidate expression using a text corpus;
selecting the candidate expression as an expression associated with the voice command based on the scoring of the candidate expression.

16. The system of claim 15, wherein a segment of the segments of text comprises a word and an argument.

17. The system of claim 15, wherein obtaining segments comprises:
obtaining the one or more expressions from an expression database;
identifying syntactic constituents in the one or more expressions; and
defining segments in the one more expressions based on the identification of the syntactic constituents.

18. The system of claim 15, wherein combining the segments comprises:
obtaining a rule for combining segments of expressions; and
applying the rule to the obtained segments.

19. The system of claim 15, wherein scoring comprises:
matching arguments in the candidate expression to text of the text corpus; and
determining the accuracy of the matching,
wherein selecting the candidate expression for inclusion in the expression database is based on determining the determined accuracy is greater than accuracy of matching of the expression database without the candidate expression.

20. The system of claim 15, wherein scoring comprises:
determining the frequency that the candidate expression is matched to text in the text corpus,
wherein selecting the candidate expression for inclusion in an expression database is based on determining the frequency is greater than a predetermined frequency threshold.
